(19) United States
(12) Patent Application Publication
(10) Pub. No.: US 2006/0057349 A1
(43) Pub. Date: Mar. 16, 2006

(54) Method and apparatus for forming integrated speaker grilles in resinated fibrous substrates

(76) Inventors: Mark K. Neitzke, Waterford, MI (US); Duane Poliquin, Brighton, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/201,746

(22) Filed: Aug. 11, 2005

Related U.S. Application Data
(60) Provisional application No. 60/600,620, filed on Aug. 11, 2004.

(51) Int. Cl. A01K 1/015

(52) U.S. Cl. 428/221

(57) ABSTRACT

A trim panel is provided comprising a decorative covering overlying a substrate and including a series of apertures formed by piercing pins for transmitting sound or air from a speaker or air outlet. The area between apertures includes a raised surface portion which supports the decorative covering and prevents readout of the apertures, and may further provide a design or logo on the surface of the trim panel.

### CROSS REFERENCE TO RELATED APPLICATION

The present application claims the benefit of the filing date of U.S. Provisional Application Ser. No. 60/600,620 filed Aug. 11, 2004, the teachings of which are incorporated herein by reference.

### FIELD OF INVENTION

The present invention relates generally to forming apertures in resinated fibrous trim panels for use in vehicles, and more particularly, to forming integral speaker grilles which hide the presence of any underlying aperture.

### BACKGROUND OF THE INVENTION

Vehicle interior panels, particularly for automobiles, have been formed from a variety of composite molded products. Construction of a skin backed by a semi-rigid foam and supported by a rigid plastic or metal substrate are well-known. More recently, cloth, fabric and carpet constructions, both woven and non-woven, have become more popular on all surfaces of the vehicle to provide differentiation in appearance and texture, as well as to provide sound attenuation. Vehicle cabin comfort and ambiance, to meet the demand for “creature features”, has been enhanced through the addition of improved quality sound systems, which may include a multiplicity of speakers located throughout the vehicle, each individually tunable to suit the preferences of the occupant. In addition, air vents for distributing filtered air to the occupants may be strategically located to provide personalized climate control. Conventionally, these speakers and air vents have been preferably located behind perforated plastic trim panels to distribute clean air or undistorted sound.

In many cases, a separate plastic molded grille has been mounted over the speaker or air outlet to prevent foreign objects from falling inside. Too often these molded plastic grilles suffer from poor fit (gap and flush) and poor color match to the surrounding trim panel. In addition, the grilles must be mounted or mechanically attached. These speakers and/or air outlets may be found nearly anywhere in the interior of today's vehicle; in the door panel, headliners, cargo door, quarter panels, pillar posts, console, package shelf, seat back, headrest and especially the instrument panel

Recent advances in electronics now provide a number of sources of high quality sound to the vehicle via satellite radio, compact disc (CD) and digital video disc (DVD) which should not suffer from distortion or be muffled by covering materials.

Providing fresh filtered air to the vehicle occupants and removing stale air is also an increasingly important feature.

What is needed is an integrated trim covering for a speaker or an air outlet which is aesthetically pleasing, blending in with the surroundings, and which can provide a free undistorted flow of air and sound, but does not provide detracting gaps and poor color match. What is needed is a process and apparatus for preparing these trim coverings.

It is thus an object of the present invention to provide a decorative trim covering for an air vent or speaker which is integrated into a trim panel and does not include distracting gaps, color mismatches or objectionable sound distortion.

It is a further object of the present invention to provide a trim panel comprising at least one layer of resinated fibrous or plastic material which includes a plurality of apertures formed in the material and covered with a porous cloth fabric or carpet.

It is still a further object of the present invention to form these apertures in the resinated fibrous or plastic material as part of the molding process for forming the trim panel, using pins which penetrate the panel, preferably from both sides.

It is still further object of the present invention to provide a stronger perforated area for transmitting sound by using tapered pins which penetrate the resinated fibrous material before it has hardened and by displacing material laterally as the pins pierce the material, densifying the material at the periphery of the apertures so formed.

It is a still further object of the present invention to provide a decorative pattern in the surface of the resinated fibrous product placed at the top surface of the material between the apertures to prevent any readthrough from the aperture beneath the trim covering. The design may be a logo or message.

### SUMMARY OF THE INVENTION

In a first embodiment the present invention relates to a trim panel for a vehicle comprising a substrate having a top surface including a series of apertures therethrough for transmitting sound or air comprising a decorative outer layer, wherein the top surface of the substrate between the apertures includes a raised surface portion and wherein the decorative outer layer bridges the apertures.

In a second embodiment the present invention is directed at a method of forming a trim panel for a vehicle including a path for sound or air transmission comprising the steps of providing a resinated fibrous mat, providing a forming mold having first and second mold portions whichcooperate to form a cavity space therebetween, providing a series of pins extending from one or both of the first and second mold portions which engage from one mold portion to the opposite mold portion when the mold portions are mated, heating said resinated fibrous mat, placing said heated mat into said cavity space, forming said heated mat into a three dimensional shape by mating said first and second mold portions, piercing said heated mat with said pins as said first and second mold portions are mated, and removing said formed three dimensional shape including a series of apertures formed by said pins from said forming mold.

In a third embodiment, the present invention is directed a method of forming a trim panel for a vehicle including a path for sound or air transmission comprising the steps of providing a substrate precursor, providing a forming mold having first and second mold portions which cooperate to form a cavity space therebetween, providing a series of pins extending from one or both of the first and second mold portions which engage from one mold portion to the opposite mold portion when the mold portions are mated, closing the first and second mold portions to form said cavity space and introducing the substrate precursor into the cavity space and around said pins, wherein an area between said pins includes recesses in either the first or second mold portions to form a raised area in the surface of the substrate, and removing said substrate from said mold wherein said substrate includes a series of apertures formed by said pins.

In a fourth embodiment the present invention is directed at an apparatus for forming apertures for transmitting air or sound through a trim panel comprising a forming mold first portion, a forming mold second portion, a series of pins extending from one or both of said first portion and said second portion in opposed fashion, wherein said first and second mold portion cooperate to form a cavity space therebetween; wherein said pins extend to said opposite mold portion from one or both of said first or second mold portion, wherein upon closing said first and second mold portions together over a fibrous substrate, said pins pierce said substrate to form said apertures.

In a fifth embodiment the present invention is directed at an apparatus for forming apertures for transmitting air or sound through a trim panel comprising a forming mold first portion, a forming mold second portion, a series of pins extending from one or both of said first portion and said second portion in opposed fashion, wherein said first and second mold portion cooperate to form a cavity space therebetween, wherein said pins extend to said opposite mold portion from one or both of said first or second mold portion, wherein one of said first or second mold portions has a surface with one or more recess portions between said pins.

### BRIEF DESCRIPTION OF THE DRAWINGS

These and other objects, features and advantages of the invention will become apparent upon consideration of the description of the invention and the appended drawings in which:

FIG. 1 is a perspective view of a trim panel which includes separate speaker grilles as may be found in the prior art.

FIG. 2 is a perspective view of a trim panel including integral speaker grille areas according to the present invention.

FIG. 3 is a cross-sectional view of FIG. 2 taken along 2-2 illustrating how the positive relief design of the present invention is formed between the apertures.

FIG. 4 is a side view of a forming tool for a resinated fibrous trim panel illustrating the tapered pins for forming apertures for the speaker grille of the present invention.

FIG. 5 is an enlarged sectional view of the tapered pins of FIG. 4.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

For elements common to the various embodiments of the invention, the numerical reference character between the embodiments is held constant, but distinguished by the addition of an alphanumeric character to the existing numerical reference character. In other words, for example, an element referenced at 10 in the first embodiment is correspondingly referenced at 10A, 10B, and so forth in subsequent embodiments. Thus, where an embodiment description uses a reference character to refer to an element, the reference character applies equally, as distinguished by alphanumeric character, to the other embodiments where the element is common.

The present invention addresses the deficiencies of the prior art by providing a trim covering for a speaker or air outlet integrated into preferably a resinated fibrous trim panel wherein the trim covering includes a decorative pattern that prevents readout of the underlying apertures which provide sound or air transmission. As the resinated fibrous trim panel is molded, provisions are made in the tooling to provide a positive relief feature in the surface of the trim panel between the apertures formed for air and sound transmission. When covered with a porous outer layer (cloth, fabric, carpet, etc.) this positive relief feature supports the outer covering layer, bridging the apertures and may provide a logo, message or other distinguishing design which prevents readthrough of the apertures.

In addition, the apertures are formed into the resinated fibrous substrate with preferably tapered pins which preferably extend into both sides of the substrate from both halves of the forming tool prior to solidifying the substrate. By using tapered pins no “waste slugs” are created and a stronger “grille” area is formed as the fibers are pushed aside or compressed laterally and formed in that position rather than being fractured by a punch die, thus the periphery of the aperture so formed becomes more fiber-rich and stronger.

In addition, another preferred embodiment is to apply the invention herein to molded plastic substrates. In such circumstances, the plastic substrate can be formed by supplying a precursor to a mold having pins extending from a tool surface to form apertures in the plastic substrate after the precursor has flowed around the pins and solidified The tooling surface can also then include recessed sections between the pins which then would form raised areas in the surface of the substrate between the apertures in the substrate. This then is followed by the application of the decorative layer to bridge and hide the apertures.

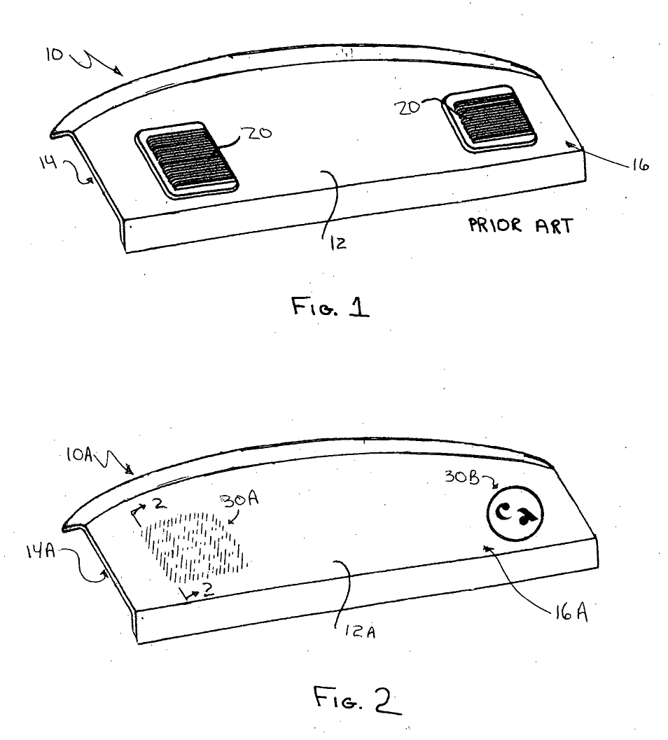

FIG. 1 illustrates a trim panel 10 for a vehicle for closing out a rear package shelf area or an instrument panel upper as known in the prior art. It typically comprises a decorative outer skin layer 12 supported by a substrate 14 and includes separate speaker grilles 20 mounted on the top surface 16. The speaker grilles 20 are separately molded and attached to the panel 10 during an assembly process, typically with mechanical fasteners, sometimes including an interference fit. The speaker grilles 20 may provide unsightly appearance due to gaps and non-flush conditions or due to a mismatch of color with the adjacent panel. The grilles also present an opportunity for collecting dust, dirt and small items that may fall inside. Other trim panels that may include a speaker grille or an air vent having similar features in a vehicle, include but are not limited to, door panels, pillars, headliners, rear quarter panels, rear cargo doors, seat backs and consoles.

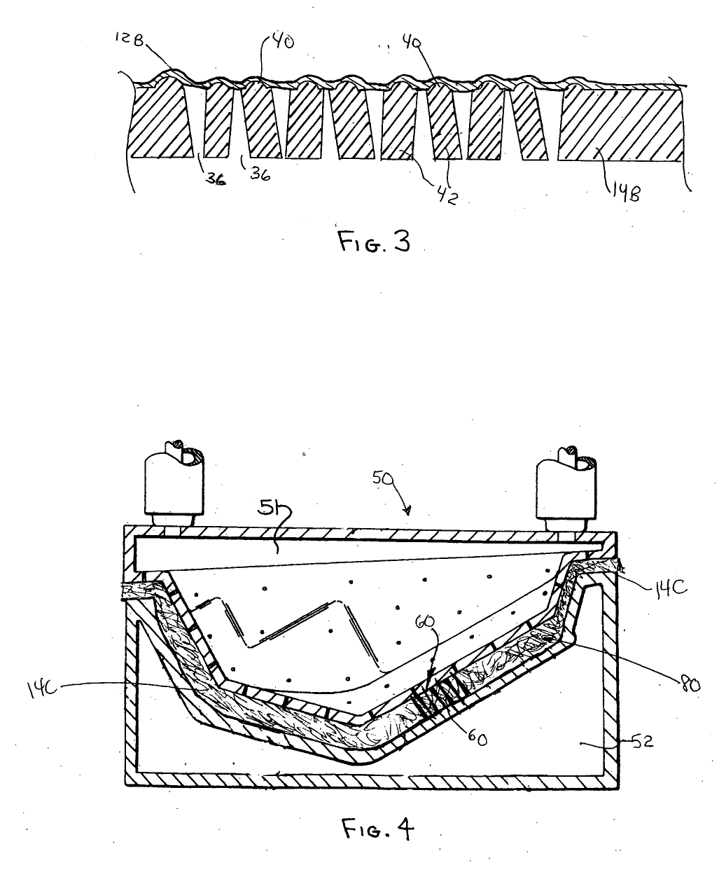

FIG. 2 illustrates an improvement in appearance as provided by the present invention. A panel 10A includes an outer decorative cover layer 12A which is at least somewhat porous and preferably a cloth, fabric or carpet composition that will allow air and sound to easily pass through. The substrate layer 14A is preferably a resinated fibrous layer or series of layers that may have sound reducing properties but may include a plastic molded substrate produced by any of the processes known in the art.

Included in the top surface 16A over each speaker or air outlet is a decorative pattern 30A, 30B in raised relief that allows the decorative cover layer 12A to bridge over holes or apertures (not shown, see FIG. 3) formed in the substrate layer 14A to transmit sound. By raising the areas between the holes above the level of the periphery of the hole, the decorative covering layer 12A can bridge the holes and the raised areas between holes can form a decorative pattern as shown in FIG. 2, preventing readthrough of the holes. FIG. 2 shows two different types of patterns 30A, 30B, although nearly any design that may be molded in relief may be possible. In one instance, the pattern may resemble a checkerboard pattern and could coordinate with a surface pattern or texture in the decorative outer layer 12A (say a plaid or herringbone cloth or fabric). In another instance, the pattern may include a company logo 30B, a vehicle model name, a message or other indicia.

The decorative covering material of the present invention is preferably formable with heat and somewhat porous, at least in the areas where air/sound must flow. Preferred materials include cloth, fabric, carpet and like woven or non-woven fibrous materials including natural fibers, synthetic fibers and combinations thereof. The substrate layer is preferably a sound reducing construction comprising one or more layers which are formable under heat and pressure. The term “sound reducing layer” is therefore defined as any material which might absorb, attenuate, insulate or serve as a barrier to sound. This may include, but is not limited to thermoformable fibrous materials, foam, highly filled thermoplastic such as massback, Maratex®, shoddy, polyester fibers, nylon fibers and bi-component fibers.

As used herein “resinated fibrous substrate” refers to any combination of fibrous materials which are heated to a temperature and formed into a three dimensional shape where upon cooling, adjacent material or fibers bond to one another. This may be accomplished by a variety of methods, one of which is heating the material or fibers to a temperature such that adjacent material or fibers bond to one another without melting. Elaborating on this concept, it can be appreciated that this is in reference to the feature of employing an amorphous polymer, as part of the material or fiber mix, wherein the amorphous polymer itself does not have a defined melting point (Tm) sufficient to soften as a consequence of a true thermodynamic melting event, and provide bonding. Instead, since the polymer is amorphous, the softening may occur at a secondary transition temperature, e.g. the glass transition temperature (Tg), or at some other temperature. Those of skill in the art will therefore appreciate that heating of, for instance, fibers to a temperature such that the adjacent fibers bond to one another without melting may occur at a temperature above the Tg of a substantially amorphous polymer material within the fiber composition. Under such circumstances, the crystalline polymer fibers of the fiber mix remain non-melted, and the amorphous polymers heated at or above their Tg will provide the bonding necessary upon cooling.

Alternatively, it is contemplated that bonding may occur via the use of binders which themselves may be chemically reactive due to the introduction of heat. For example, one may optionally employ a binder system that includes a component, such as a polymeric precursor, which undergoes chemical crosslinking, as in the case of a thermoset type precursor. Alternatively, one may optionally elect to use a moisture cure system, wherein the component, such as a polymer resin, will, upon introduction of heat and moisture, react and solidify upon cooling to provide binding within the perform.

Furthermore, one may also use a non-reacting binder system, e.g., a urethane water dispersion which can be used to coat a material or fibers and which upon heating and evaporation of the water provides bonding of adjacent material or fibers to form a perform. Again, this would be another example of material or fiber bonding without the fibers of the perform themselves melting.

In an even further embodiment, one could also utilize a component binder, such as a polymer, with a melting point below the melting point of the fibers of the preform, which polymer binder could be applied to the fibers, say by spraying, which would experience melting at elevated temperature to cause bonding of adjacent fibers within the perform when cooled. Again, this would be yet another example of material of fiber bonding without the fibers of the perform themselves melting.

Alternatively, the resinated fibrous layer may comprise a blend of fibers having different melting points, where upon heating, the fibers having the lower melting point melt and, upon cooling, bond the rest of the higher melting point fibers together.

The decorative covering layer may be a porous carpet layer as disclosed in U.S. application Ser. No. 10/253,373 filed Sep. 4, 2002, entitled “Porous Carpeting For Vehicle And Methods Of Producing Same”, assigned to the assignee of the present invention and included herein by reference.

The decorative outer layer 12A and substrate layer 14A or layers are preferably combined in a compression molding process as known to those skilled in the art where the covering layer and substrate are heated, placed in layered relationship in a mold set and compressed slightly and allowed to cool. In this case, holes may be formed through both the substrate and decorative covering and are visible in the decorative covering after molding. In a second, preferred, embodiment, the substrate layer is heated and formed in a first compression tool and the holes or apertures for the speaker grille or air outlet are formed during the molding process. Subsequently, the decorative outer covering layer is applied to the top surface of the substrate layer, over the raised areas between apertures, in a second molding process. This provides a decorative cover with no visible holes for a speaker or air outlet.

Methods of forming porous carpeting/sound reducing substrate combinations are disclosed in World Patent Application PCT US04/07024, entitled “Methods Of Forming Decouplers For Vehicle Interior Components”, filed Mar. 9, 2004; U.S. application Ser. No. 10/775,548, entitled “Methods Of Forming Vehicle Interior Components Which Include A Decoupler Layer”, filed Feb. 10, 2004; U.S. application Ser. No. 10/776,015, entitled “Rotary Apparatus For Forming Decouplers For Vehicle Interior Components”, filed Feb. 10, 2004; and U.S. application Ser. No. 10/775,549, entitled “Contoured Mold For Forming Decouplers For Alternating Sound In A Vehicle”, filed Feb. 10, 2004; all assigned to the assignee of the present invention and included herein by reference.

FIG. 3 is a sectional view taken through the hole pattern of 30A in FIG. 2 illustrating the positive relief features or raised surface areas 40 of the present invention which allow the decorative covering 12B to drape across the aperture or opening 36 and prevent readthrough. As shown in FIG. 3, the holes or apertures 36 for transmitting sound or air through the speaker or air outlet area 30A, 30B are preferably formed of pins having a slight draft (exaggerated in FIG. 3) and preferably formed by piercing from both sides of the substrate, the pins extending from both surfaces of the forming tool. By having a draft on the piercing pins, the material 42 between the pins or formed apertures 36 is compressed laterally as the pins penetrate the substrate layer, adding strength between the apertures 36. By using tapered piercing pins, the fibers of the substrate 14B are pushed aside rather than being severed, again adding strength. Typically, to provide minimal distortion of sound in a speaker area, the area of the apertures should comprise about 65% or more of the overall speaker area 30A, 30B.

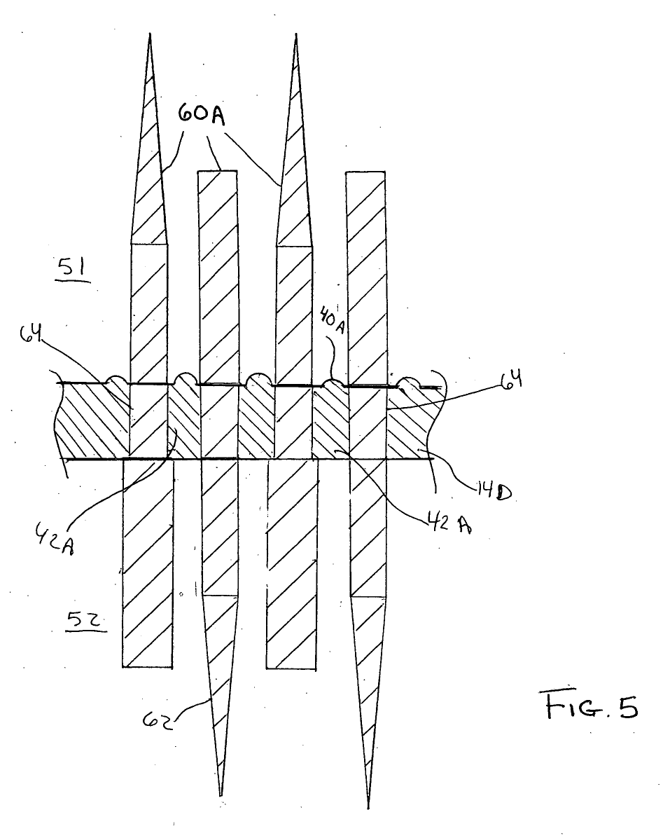

FIG. 4 illustrates the placement of the tapered pins 60 extending from both sides of a forming tool to create the apertures in the trim panel substrate. Here, a forming mold 50 comprises an upper portion or lid 51 and a lower portion or cavity 52 which cooperate to form a space 80 therebetween for forming a trim panel substrate 14C from a fibrous layer or composite of layers.

The pins 60 of the present invention which form the apertures 36 (see FIG. 3) are place into the surface of the lid 51 and the cavity 52 of the forming mold so that the pins extending from each surface are opposed and offset to form a pattern of apertures 36 in the substrate 14B (see FIG. 3).

In FIG. 4 the pins 60 are shown extending into the opposite mold portion to prevent misalignment. By having pins extending from each mold portion and by varying the taper on one set of pins, say for the lid, from the taper for the pins in the cavity, it is possible to control which mold portion the substrate will be retained by upon mold opening, reducing the potential for tearing of the substrate and easing substrate removal and handling. Although not preferred, it is contemplated that holes may be formed in a composite of a decorative cover and fibrous substrate as it is being formed in a mold, however, some readout of the holes may occur in the decorative cover, which may further form part of the decorative pattern or design overlying the speaker or air outlet.

FIG. 5 shows an enlarged view of the piercing pins 60A of the present invention forming a portion of a speaker area in a fibrous substrate 14D. Here, the pins 60A are shown fully engaged with the opposing portion 51, 52 and penetrating the substrate 14D as it is being formed. The pins 60A preferably comprise a piercing section 62 for penetrating the fibrous substrate 14B without severing the fibers, and a tapered section 64 which provides some compression of the substrate material between the pins 42A thus adding strength to the perforated area. In one embodiment, the pins of the present invention were about 0.25″ square and about 5 inches long. The distance between the edges of the pins (42A) was about 0.030″. The draft angle 64 was about 1°. The substrate 14D thickness after forming to shape was about 0.4 inches. However, the pins may be of nearly any size and shape; rectangular, round, oval, multisided, etc. Also shown are the raised relief areas 40A formed between the holes to provide the decorative pattern and prevent readout.

Preferably, the raised portion between the apertures comprise raised portions that are of substantially similar height. Alternatively, the raised portions 40A between the apertures comprise raised portions that differ in height. In either event, the raised portions between the apertures 36 that are raised relative to other locations on the top surface of the substrate may be raised in the range of 0.010-0.250 inches, including all incremental values therebetween.

Thus, the present invention provides a trim panel including a series of apertures for transmitting sound or air having an improved surface appearance and added strength in the apertured area by providing the apertures formed by tapered piercing pins in a resinated fibrous substrate. The trim panel further includes raised surface areas between the apertures which allow a decorative trim covering to bridge the apertures, preventing readout and further providing a decorative design in place of a separate grille.

What is claimed is:

1. A trim panel for a vehicle comprising
a substrate having a top surface including a series of apertures therethrough for transmitting sound or air comprising:
a decorative outer layer;
wherein the top surface of the substrate between the apertures includes a raised surface portion and wherein the decorative outer layer bridges the apertures.

2. The trim panel of claim 1 wherein the substrate comprises a resinous fibrous substrate.

3. The trim panel of claim 1, wherein the series of apertures overly a speaker or air outlet.

4. The trim panel of claim 1, wherein the decorative outer layer is porous.

5. The trim panel of claim 4, wherein the decorative outer layer is a cloth, fabric or carpet.

6. The trim panel of claim 2, wherein the resinated fibrous substrate comprise fibers and a binder material.

7. The trim panel of claim 6, wherein the binder material has a melting point, and the fibers have a melting point, and the fiber material melting point is lower than the melting point of the fibers.

8. The trim panel of claim 7, wherein the binder material is a portion of or all of a fiber.

9. The trim panel of claim 1, wherein the raised portion between the apertures covered by the outer layer forms a decorative pattern.

10. The trim panel of claim 1 wherein the raised portion between the apertures comprises a raised portion that is raised relative to other locations on the top surface of the substrate.

11. The trim panel of claim 1 wherein the raised portion between the apertures comprises raised portions that are of substantially similar height.

12. The trim panel of claim 1 wherein the raised portion between the apertures comprises raised portions that differ in height.

13. The trim panel of claim 10 wherein the raised portion between the apertures that is raised relative to other locations on the top surface of the substrate is raised in the range of 0.010-0.250 inches.

14. A method of forming a trim panel for a vehicle including a path for sound or air transmission comprising the steps of:
providing a resinated fibrous mat;
providing a forming mold having first and second mold portions which cooperate to form a cavity space therebetween;
providing a series of pins extending from one or both of the first and second mold portions which engage from one mold portion to the opposite mold portion when the mold portions are mated;
heating said resinated fibrous mat;
placing said heated mat into said cavity space;
forming said heated mat into a three dimensional shape by mating said first and second mold portions;
piercing said heated mat with said pins as said first and second mold portions are mated; and
removing said formed three dimensional shape including a series of apertures formed by said pins from said forming mold.

15. The method of claim 14, further including applying a decorative outer layer over said three dimensional shape wherein the areas between said apertures include raised surface portions in the top surface of the three dimensional shape.

16. The method of claim 14, wherein the series of apertures overly a speaker or air outlet.

17. The method of claim 15, wherein the decorative outer layer is porous.

18. The method of claim 15, wherein the decorative outer layer is a cloth, fabric or carpet.

19. The method of claim 14, wherein the resinated fibrous substrate comprise fibers and a binder material.

20. The method of claim 19, wherein the binder material has a melting point, the fibrous material has a melting point, and the binder melting point is lower than the melting point of the fibrous material.

21. The method of claim 19, wherein the binder material is a portion of or all of a fiber.

22. The method of claim 14 wherein said pins are tapered.

23. A method of forming a trim panel for a vehicle including a path for sound or air transmission comprising the steps of:
providing a substrate precursor;
providing a forming mold having first and second mold portions which cooperate to form a cavity space therebetween;
providing a series of pins extending from one or both of the first and second mold portions which engage from one mold portion to the opposite mold portion when the mold portions are mated;
closing the first and second mold portions to form said cavity space and introducing the substrate precursor into the cavity space and around said pins
wherein an area between said pins includes recesses in either the first or second mold portions to form a raised area in the surface of the substrate; and
removing said substrate from said mold wherein said substrate includes a series of apertures formed by said pins.

24. The method of claim 23, further including applying a decorative outer layer over said substrate.

25. The method of claim 23, wherein the substrate is positioned so that said apertures overly a speaker or air outlet.

26. The method of claim 24, wherein the decorative outer layer is porous.

27. The method of claim 24, wherein the decorative outer layer is a cloth, fabric or carpet.

28. The method of claim 23 wherein said pins are tapered.

29. An apparatus for forming apertures for transmitting air or sound through a trim panel comprising:
a forming mold first portion;
a forming mold second portion;
a series of pins extending from one or both of said first portion and said second portion in opposed fashion;
wherein said first and second mold portion cooperate to form a cavity space therebetween;
wherein said pins extend to said opposite mold portion from one or both of said first or second mold portion;
wherein upon closing said first and second mold portions together over a fibrous substrate, said pins pierce said substrate to form said apertures.

30. The apparatus of claim 29, wherein one of said first and said second mold portions includes depressions in the mold surface between said pins.

31. An apparatus for forming apertures for transmitting air or sound through a trim panel comprising:
a forming mold first portion;
a forming mold second portion;
a series of pins extending from one or both of said first portion and said second portion in opposed fashion;
wherein said first and second mold portion cooperate to form a cavity space therebetween;
wherein said pins extend to said opposite mold portion from one or both of said first or second mold portion;
wherein one of said first or second mold portions has a surface with one or more recess portions between said pins.
